(19) United States
(12) Patent Application Publication
(10) Pub. No.: US 2019/0012553 A1
(43) Pub. Date: Jan. 10, 2019

(54) DIAGNOSTIC DEVICE, DIAGNOSIS METHOD AND COMPUTER PROGRAM

(71) Applicant: Kabushiki Kaisha Toshiba, Tokyo (JP)

(72) Inventors: Kohei MARUCHI, Setagaya Tokyo (JP); Topon PAUL, Kawasaki Kanagawa (JP); Genta KIKUCHI, Kamakura Kanagawa (JP); Sayaka AKIYAMA, Yokohama Kanagawa (JP)

(73) Assignee: Kabushiki Kaisha Toshiba, Tokyo (JP)

(21) Appl. No.: 15/911,239

(22) Filed: Mar. 5, 2018

(30) Foreign Application Priority Data
Jul. 7, 2017 (JP) 2017-133749

(51) Int. Cl. G06K 9/03; G06T 11/20; G06F 15/18

(52) U.S. Cl. CPC G06K 9/03; G06F 15/18; G06T 11/206

(57) ABSTRACT

According to one embodiment, a diagnostic device includes

an anomaly diagnoser and a graph creator. The anomaly diagnoser performs anomaly diagnosis based on first measured data. The graph creator determines parameter information for graph production in accordance with a result of the anomaly diagnosis and creates a first graph from the first measured data based on the parameter information.

### CROSS REFERENCE TO RELATED APPLICATIONS

This application is based upon and claims the benefit of priority from the prior Japanese Patent Application No. 2017-133749, filed on Jul. 7, 2017, the entire contents of which are incorporated herein by reference.

### FIELD

Embodiments described herein relate to a diagnostic device, a diagnosis method, and a computer program.

### BACKGROUND

The recent progress of information and communication technology (ICT) and reduction of the size and price of a sensor has enabled collection of big data. Effective use of such big data is expected. The technology of anomaly detection and fault identification (identification of anomaly factor) in a system through machine learning of temporally sequential data obtained from a plurality of sensors has been researched and developed in the field of social infrastructure such as power generation station, plant, and traffic. Work of monitoring and diagnosing social infrastructure largely depends on accumulated experience and sense of a maintenance person, and thus appropriate and fast diagnosis is difficult to perform by those other than maturely skilled people. Thus, the effective use of machine learning in the social infrastructure field can be one of solutions to continuously maintain the social infrastructure in shortage of labor.

However, when a system is monitored and diagnosed by using only a model generated by machine learning, risk exists that false determination that would not be made by the skilled maintenance person (operator) potentially occurs in a case of, for example, data having properties completely different from those in the past. The false determination can cause problems such as no alert notification in an anomaly state, alert notification in a normal state, and worsened situation by a wrong measure. In particular, in social infrastructure, a wrong measure has large influence, potentially badly affecting reliable operation maintenance.

### BRIEF DESCRIPTION OF THE DRAWINGS

FIG. 1 is a block diagram of an anomaly diagnosis system according to an embodiment of the present invention.

FIG. 2 is a diagram illustrating exemplary measured data.

FIG. 3 is a diagram illustrating an exemplary diagnosis evaluation screen including diagnosis result information and a graph.

FIG. 4 is a diagram illustrating exemplary production of a trend graph.

FIG. 5 is a diagram illustrating exemplary production of a scatter diagram.

FIG. 6 is a diagram illustrating exemplary production of a histogram.

FIG. 7 is a diagram illustrating exemplary production of a box plot.

FIG. 8 is a diagram illustrating an exemplary graph when anomaly is detected.

FIG. 9 is a diagram illustrating an exemplary display history database.

FIG. 10 is a diagram illustrating an exemplary diagnosis history database.

FIG. 11 is a diagram illustrating an exemplary anomaly detection model by linear regression.

FIG. 12 is a diagram illustrating an exemplary factor classification model by using the random forest.

FIG. 13 is a diagram illustrating an exemplary factor classification model by using the k-nearest neighbor algorithm.

FIG. 14 is a diagram illustrating another exemplary display of diagnosis result information.

FIG. 15 is a diagram illustrating an exemplary relation between an anomaly degree and an anomaly probability.

FIG. 16 is a flowchart of entire processing at a diagnostic device according to the embodiment of the present invention.

FIG. 17 is a flowchart of diagnosis processing and graph production processing.

FIG. 18 illustrates a detailed flowchart of graph production processing.

FIG. 19 is a flowchart of diagnosis result evaluation processing according to the embodiment of the present invention.

FIG. 20 is a flowchart of model generation processing according to the embodiment of the present invention.

FIG. 21 is a diagram illustrating a hardware configuration of the diagnostic device according to the present embodiment of the present invention.

### DETAILED DESCRIPTION

According to one embodiment, a diagnostic device includes an anomaly diagnoser and a graph creator. The anomaly diagnoser performs anomaly diagnosis based on first measured data. The graph creator determines parameter information for graph production in accordance with a result of the anomaly diagnosis and creates a first graph from the first measured data based on the parameter information.

An embodiment of the present invention will be described below with reference to the accompanying drawings. Identical components in the drawings are denoted by identical reference numerals, and any duplicate description thereof will be omitted as appropriate.

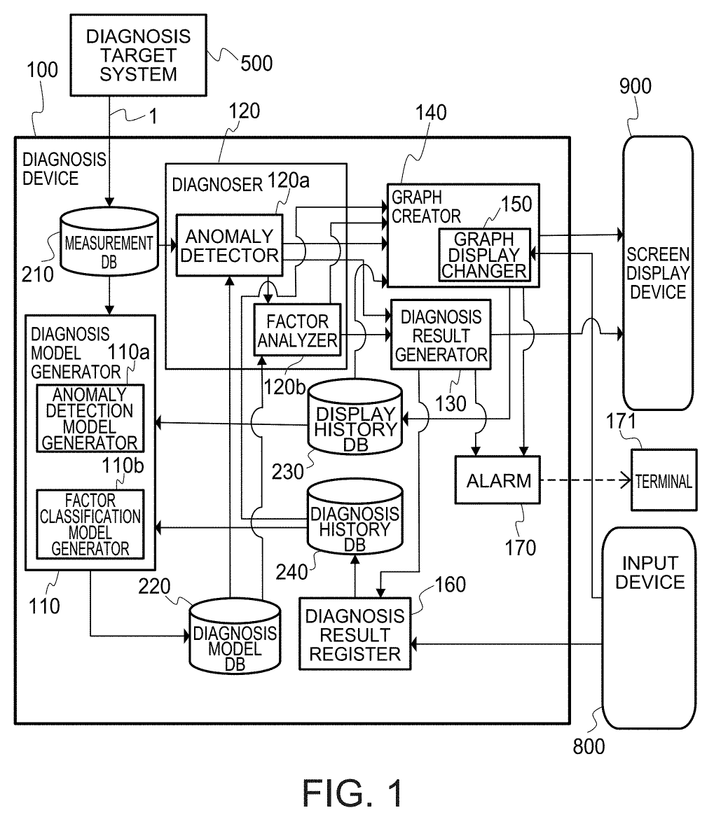

FIG. 1 is a block diagram of an anomaly diagnosis system according to the embodiment of the present invention. The following first describes the outline of the configuration of the anomaly diagnosis system.

The anomaly diagnosis system according to a first embodiment includes a diagnostic device 100, a diagnosis target system 500, an input device 800, and a screen display device 900. The diagnosis target system 500 is a system to be monitored and diagnosed by the diagnostic device 100. The outline of the diagnostic device 100 will be described below.

The diagnostic device 100 performs anomaly diagnosis of the diagnosis target system 500 by using a diagnosis model generated by machine learning in advance based on measured data 1 (for example, data measured by a plurality of sensors) of the diagnosis target system 500. The diagnostic device 100 generates, from the measured data 1, a graph referred to by a user such as a maintenance person or an operator (hereinafter collectively referred to as a maintenance person) to determine the validity of an anomaly diagnosis result. The diagnostic device 100 displays the created graph together with the anomaly diagnosis result on the screen display device 900.

The graph generation is performed based on, for example, a history database (display history database 230, diagnosis history database 240) storing a result of anomaly diagnosis performed in the past, and parameter information of a graph determined, by the maintenance person, to be effective for determining the validity of the anomaly diagnosis result. Parameter information for graph production (which is below called graph production parameter information or parameter information) is determined from the history database, and a graph is generated based on the determined parameter information. The parameter information specifies, for example, a condition of data extraction from measured data, a variable (such as a sensor value or a feature amount calculated from sensor values of one or more sensors) used in the graph production, and the type of a created graph.

The maintenance person refers to the displayed graph to determine whether a result of the anomaly diagnosis using the diagnosis model is valid (correct). When the correctness of the anomaly diagnosis result cannot be determined from the displayed graph, the maintenance person specifies the graph production parameter information by using the input device 800 and causes the diagnostic device 100 to recreate a graph. The diagnostic device 100 recreates a graph from the parameter information specified by the maintenance person and displays the recreated graph. The maintenance person repeats specification of the graph production parameter information and display of a graph until the validity of the anomaly diagnosis result can be determined from the graph.

When having determined from the displayed graph that the anomaly diagnosis result is not valid (not correct), the maintenance person corrects the anomaly diagnosis result by providing a correct instruction to the diagnostic device 100. The diagnosis history database 240 stores a final anomaly diagnosis result approved by the maintenance person, and the display history database 230 stores parameter information of a graph approved by the maintenance person, which is effective for determining the validity of the anomaly diagnosis result. These history databases are utilized in graph production at the next anomaly diagnosis to increase the probability that a graph effective for determining the validity of an anomaly diagnosis result is presented to the maintenance person in the first place. Accordingly, the maintenance person can determine fast the validity of an anomaly diagnosis result. The diagnostic device 100 thus configured will be described in detail below.

The diagnostic device 100 includes a diagnosis model generator 110, a diagnoser 120, a diagnosis result generator 130, a graph creator 140, a graph display changer 150, a diagnosis result register 160, an alarm 170, a measurement database 210, a diagnosis model database 220, and the history databases (the display history database 230 and the diagnosis history database 240)

The diagnosis model generator 110 includes an anomaly detection model generator 110a and a factor classification model generator 110b. The diagnoser 120 includes an anomaly detector 120a and a factor analyzer 120b.

In FIG. 1, the databases 210, 220, 230, and 240 are all disposed inside the diagnostic device 100. However, the databases may be disposed in any manner. For example, part of the databases may be disposed in, for example, an external server or storage device. The databases may be achieved by a relational database management system or various NoSQL systems, but any other scheme is applicable. The storage format of each database may be XML, JSON, CSV, or any other format such as a binary format. Not all databases inside the diagnostic device 100 need to be achieved by an identical storage format in an identical database system, but a plurality of schemes are applicable in mixture.

The diagnostic device 100 acquires the measured data 1 of the diagnosis target system 500 and stores the acquired measured data 1 in the measurement database 210. The measured data 1 may be received from the diagnosis target system 500, for example, in the form of electric signal through a network. Alternatively, the measured data 1 may be stored in a storage medium such as a memory device by a user such as the maintenance person in advance and then used as the measurement database 210.

The reception of the measured data 1 from the diagnosis target system 500 may be achieved by an optional scheme such as Ethernet, wireless LAN, universal serial bus (USB), Bluetooth, or RS-232C.

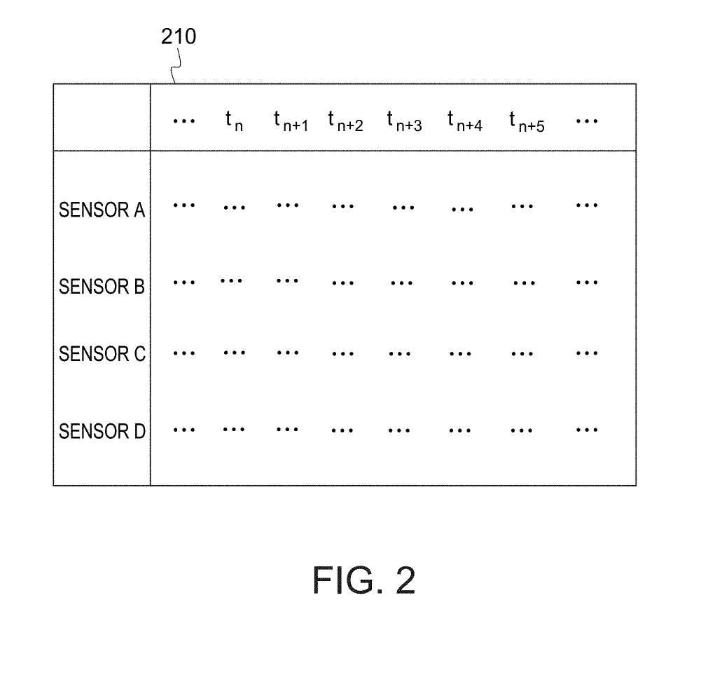

The measured data 1 includes data measured by one or a plurality of sensors. Measured data includes a measurement time and a sensor value. FIG. 2 illustrates exemplary measured data. The exemplary data illustrated in FIG. 2 is measured by four sensors. Examples of the kind of measured data include a temperature, a flow rate, a current, a voltage, a pressure, an operation command by a person, the position of an object in operation, a surrounding environment, and any other kind. Each measurement time of the measured data 1 may be provided with a label indicating whether a diagnosis target system is anomalous or normal, and a label indicating a factor of anomaly when the system is anomalous. The labeling of measured data may be performed by the maintenance person operating the input device 800 by referring to the screen display device 900. The labeling of whether the system is anomalous or normal and the labeling of an anomaly factor may be performed by feeding back a diagnosis result according to the present embodiment as described later.

The diagnosis target system 500 is a system to be monitored and diagnosed by the diagnostic device 100. This system may be a single device configured to perform monitoring and diagnosis or may include a plurality of devices configured to perform monitoring and diagnosis. In the present embodiment, the case of a single device is assumed when not explicitly stated otherwise. The diagnosis target may be a set of a plurality of devices, and comprehensive diagnosis may be performed. Diagnosis in the present embodiment includes estimation of whether anomaly is detected and estimation of an anomaly factor when anomaly is detected.

The input device 800 provides an interface for operation by the maintenance person. The input device 800 includes a mouse, a keyboard, a voice recognition system, an image recognition system, a touch panel, or a combination of these devices. The maintenance person can input various kinds of commands or data to the diagnostic device 100 through the input device 800 to perform operation.

The screen display device 900 displays a still image or a moving image of data or information output from the diagnostic device 100. The screen display device 900 is assumed to perform display by a liquid crystal display (LCD), an organic electroluminescence display, or a vacuum fluorescent display (VFD), but may be a display device in any other scheme.

The input device 800 and the screen display device 900 are connected with the diagnostic device 100. The connection may be connection with an electric communication line, such as the Internet through Ethernet or wireless LAN, serial communication cable connection, or connection in any other scheme. The input device 800 and the screen display device 900 may be each, for example, a personal computer, a smartphone, or a tablet.

In FIG. 1, the input device 800 and the screen display device 900 are independent from the diagnostic device 100, but may be physically integrated with the diagnostic device 100. The input device 800 and the screen display device 900 may be one integrated device. For example, a display with a touch panel function may be used.

The diagnosis model generator 110 uses measured data stored in the measurement database 210 to generate a diagnosis model (anomaly detection model, factor classification model) used for anomaly diagnosis of the diagnosis target system 500. Measured data used to generate a diagnosis model is referred to as learning data. The diagnosis model generator 110 includes the anomaly detection model generator 110a configured to generate an anomaly detection model by machine learning and the factor classification model generator 110b configured to generate a factor classification model by machine learning. The generated anomaly detection model and the generated factor classification model are stored in the diagnosis model database 220.

An anomaly detection model is, in the measured data 1, a model for estimating whether the diagnosis target system 500 has anomaly by using data (sample data) for the current diagnosis. The sample data may be measured data at the measurement time of the diagnosis or measured data in a certain period including a plurality of measurement times. The sample data may be defined by a method other than the above-described method, such as a method of performing anomaly diagnosis.

A factor classification model is a model for estimating, when anomaly is detected by using the anomaly detection model, a factor of the anomaly by using the sample data. Specification of a factor allows the maintenance person or the like to adopt measures appropriate for the anomaly factor. Sample data used in the factor classification model is assumed to be identical to the sample data used in the anomaly detection model, but is not limited thereto.

A plurality of anomaly detection models and a plurality of factor classification models may be prepared for one system. In this case, anomaly diagnosis may be performed by comparing estimation results by the anomaly detection models, and an anomaly factor may be specified by comparing the factor classification models. Alternatively, a plurality of anomaly detection models and a plurality of factor classification models may be prepared in accordance with the state, surrounding situation, and the like of the diagnosis target system 500 and selectively used in anomaly diagnosis in accordance with the current state or surrounding situation. For example, a plurality of anomaly detection models and a plurality of factor classification models may be prepared in accordance with a system operational state such as an operation mode or an operation state, a system load such as an outputting level or the number of passengers and cargoes, and a system use environment such as weather or season. In this case, an anomaly detection model and a factor classification model in accordance with the state, load, or use environment need to be used in anomaly diagnosis. When there are a plurality of systems, an anomaly detection model and a factor classification model may be prepared for each system or an identical anomaly detection model and an identical factor classification model may be used for a plurality of systems having common properties. The configurations of an anomaly detection model and a factor classification model and methods of generating these models will be described later in detail.

The diagnoser 120 reads sample data as a diagnosis target from the measurement database 210, and performs anomaly diagnosis on the read sample data by using an anomaly detection model and a factor classification model for a diagnosis target system, which are stored in the diagnosis model database 220. The sample data as a diagnosis target may be specified by the maintenance person through the input device 800, or may be latest sample data yet to be diagnosed or sample data determined by any other method.

The anomaly detector 120a performs, on the sample data as a diagnosis target by using an anomaly detection model, estimation of whether the diagnosis target system 500 has anomaly. Sample data when the diagnosis target system 500 is determined to be anomalous is also referred to as anomalous data. Sample data when the diagnosis target system 500 is determined to be normal is also referred to as normal data.

The factor analyzer 120b estimates an anomaly factor by using a factor classification model when the anomaly detector 120a has detected anomaly.

The result generator 130 creates diagnosis result information (report) in accordance with a result of the anomaly diagnosis by the diagnoser 120, and displays the created diagnosis result information on the screen display device 900. The diagnosis result information includes information related to a result of the anomaly detection by the anomaly detector 120a, and information related to the anomaly factor estimated by the factor analyzer 120b when the anomaly detector 120a has detected anomaly.

The graph creator 140 creates, from the measured data 1 in accordance with the anomaly diagnosis result, a graph effective for the maintenance person to determine the validity (correctness) of the anomaly diagnosis result. The graph production is performed by using a display history database and the diagnosis history database 240 to be described later. The graph creator 140 displays the created graph on the screen display device 900. The graph is displayed on the screen display device 900 together with the diagnosis result information output from the diagnosis result generator 130. The maintenance person determines the accuracy of content of the diagnosis result information by referring to the displayed graph. In other words, the graph is used as support information for determining the validity of the anomaly diagnosis result. The graph is desired to facilitate determination of the accuracies of anomaly detection and factor classification by the maintenance person.

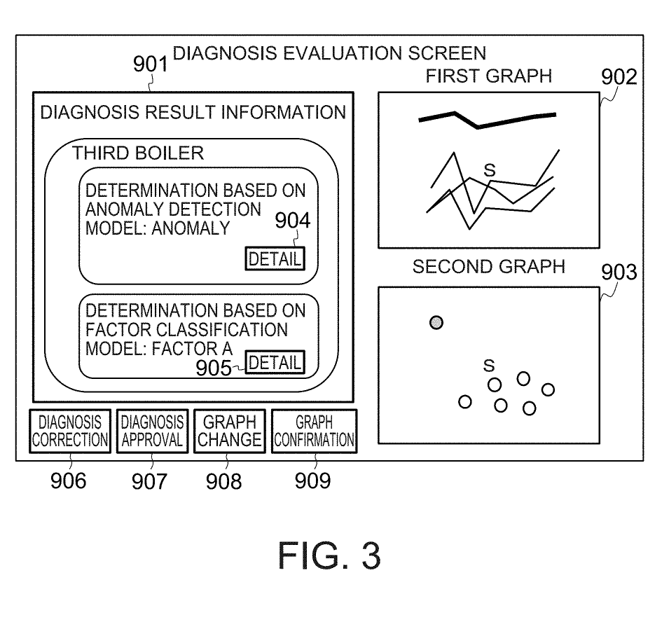

FIG. 3 illustrates exemplary display of a diagnosis evaluation screen including diagnosis result information 901 and graphs (a first graph 902 and a second graph 903). In this example, a diagnosis target is a “third boiler”, anomaly is detected by using an anomaly detection model. When a detail button 904 is selected, detail information related to the anomaly is presented. An anomaly factor is determined to be factor A by using a factor classification model. When a detail button 905 is selected, the anomaly factor is presented in detail. A trend graph is displayed as the first graph 902, and a scatter diagram is displayed as the second graph 903. The number of displayed graphs may be one or may be three or more. Methods of producing the graphs will be described later.

The maintenance person determines whether the determination results by using the anomaly detection model and the factor classification model are valid by referring to the graphs 902 and 903. When the validity of the determination results cannot be determined from the graphs 902 and 903, the maintenance person instructs production of different graphs through a graph change button 908. In this case, new parameter information for graph production is specified. As described later, the graph display changer 150 recreates a graph based on the specified parameter information and displays the graph on the screen display device 900 in place of the first graph or the second graph. The maintenance person can repeat the graph production and display until a valid graph can be checked.

When having determined that at least one of the determination results by using the anomaly detection model and the factor classification model is invalid, the maintenance person can correct the determination result through a diagnosis correction button 906.

The maintenance person presses a graph confirmation button 909 to instruct registration of a graph useful for the determination of the validity of the determination results by using the anomaly detection model and the factor classification model. When a graph does not need to be registered, selection of the graph is excluded. The graph creator 140 registers, to the display history database 230, parameter information of a graph selected through the graph confirmation button 909, and an ID (display ID) or the like for specifying the parameter information of the graph. In addition, IDs for specifying diagnosis models (anomaly detection model and factor classification model) used for the anomaly diagnosis may be registered to the display history database 230.

When the determination of anomaly of the diagnosis target system 500 and an anomaly factor has been confirmed, the maintenance person presses a diagnosis approval button 907 to instruct registration of the determination. The pressing of the diagnosis approval button 907 indicates registration instruction. The diagnosis result register 160 to be described later registers the current diagnosis result (anomaly detection result and anomaly factor) and the display ID of a graph used to determine the validity of the diagnosis result to the diagnosis history database 240. In addition, IDs for specifying diagnosis models (anomaly detection model and factor classification model) used for the anomaly diagnosis may be registered to the diagnosis history database 240.

In this manner, the display history database 230 and the diagnosis history database 240 are updated to achieve increased effectiveness of a first graph created by the graph creator 140 at subsequent anomaly diagnosis. This can reduce a load on the maintenance person when producing a graph, and lead to fast determination of the validity of a result of anomaly diagnosis by the diagnoser 120. For example, sample data (measured data) used at the current anomaly diagnosis corresponds to first measured data, and a graph created at the current anomaly diagnosis corresponds to a first graph. Sample data (measured data) used at the next anomaly diagnosis corresponds to second measured data according to the present embodiment, and a graph created at the next anomaly diagnosis corresponds to a second graph.

The following describes exemplary graph production by the graph creator 140. The graph creator 140 creates a graph based on the graph production parameter information (such as a data extraction condition, a used variable, and a graph type) by using measured data including sample data used for the current diagnosis. Exemplary graphs will be described below.

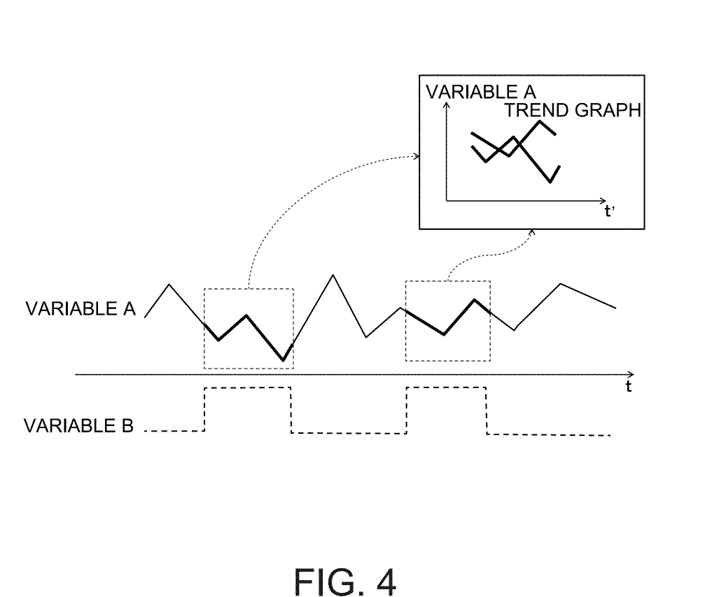

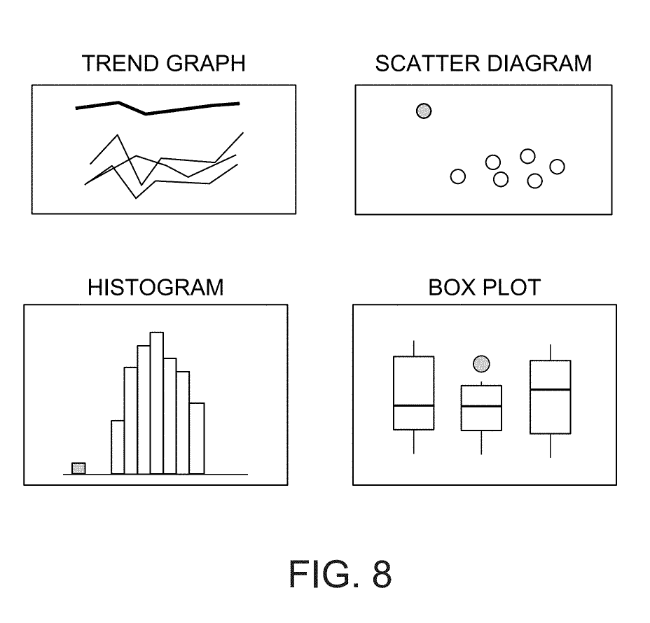

FIG. 4 illustrates an exemplary trend graph. Variable A represents a measured value of Sensor A. Variable B represents a measured value of Sensor B and takes two values to indicate whether Sensor B is on or off. The measured value of Sensor B is one when Sensor B is on, or zero when Sensor B is off. Measured data of Sensor A when Sensor B is on is surrounded by a rectangle illustrated with a dashed line. The measured data inside each rectangle is extracted and plotted on the same coordinate system to obtain a trend graph on the upper-right side in FIG. 4. The trend graphs of the respective measured data start at the same position to allow comparison between the trend graphs. For example, when anomaly of a diagnosis target system is detected based on certain sample data, large deviation of a trend graph in the sample data, which corresponds to a case in which Sensor B is on, from normal sample data (refer to FIG. 3 or FIG. 8 to be described later) can be information effective for determining this sample data to be anomalous data. In this example, the graph production parameter information corresponds to information indicating production of a trend graph of the value of Variable A when Variable B is on (one). The range of data used for graph production includes, for example, sample data used for the current anomaly diagnosis, and data a fixed time earlier such as sample data used for a plurality of times of anomaly diagnosis performed earlier (this sample data may be limited to sample data a diagnosis result of which is normal). A condition on the range of used data may be determined by default.

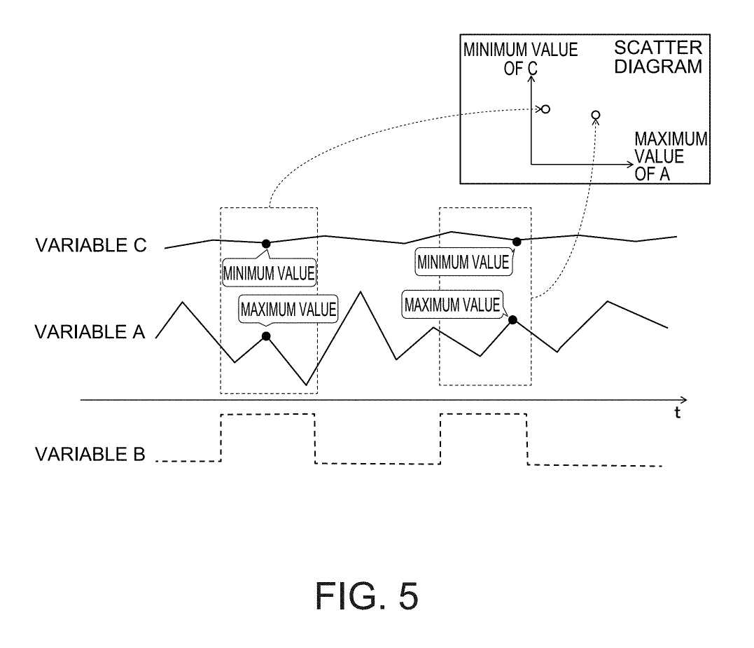

FIG. 5 illustrates an exemplary scatter diagram. Variables A and B are same as those in FIG. 4. Variable C represents a measured value of Sensor C. The scatter diagram illustrated on the right side in FIG. 5 is created by plotting the maximum value of Sensor A and the minimum value of Sensor C during an interval in which Sensor B is on. The graph production parameter information corresponds to information indicating production of a scatter diagram plotting a pair of the maximum value of Variable A and the minimum value of Variable C when Variable B is on (one). The range of data used for graph production includes, for example, sample data used for the current anomaly diagnosis, data a fixed time earlier such as sample data used for a plurality of times of anomaly diagnosis performed earlier (this sample data may be limited to sample data a diagnosis result of which is normal).

A scatter diagram may be created by generating a variable indicating a ratio of the maximum value of Variable A and the minimum value of Sensor C in place of the pair of the maximum value of Variable A and the minimum value of Variable C, and plotting the variable on a coordinate system having a vertical axis of the variable and a horizontal axis of another value (for example, the maximum value of Variable A or the minimum value of Variable C). Alternatively, a trend graph having a vertical axis of the variable indicating the ratio and a horizontal axis of time may be created.

Alternatively, a scatter diagram may be created by generating a variable indicating the difference between the maximum value of Variable A and the minimum value of Variable C, and plotting the variable on a coordinate system having a vertical axis of the variable indicating the difference and a horizontal axis of another value (for example, the maximum value of Variable A or the minimum value of Variable C). Alternatively, a trend graph having a vertical axis of the variable indicating the difference and a horizontal axis of time may be created.

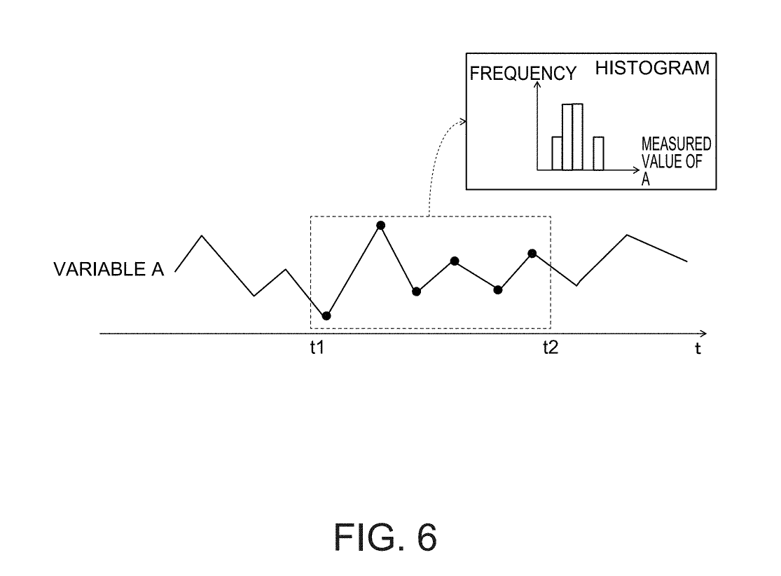

FIG. 6 illustrates an exemplary histogram. Variable A is same as that in FIGS. 4 and 5. In this example, the histogram is created for measured data of Variable A in a fixed time. The fixed time has a range of time t1 to t2. The histogram indicates the frequency of each of a plurality of classes obtained by dividing the range of the value of Variable A. A time at which anomaly diagnosis is performed is included in the range of time t1 to t2. The range of time t1 to t2 may be relatively determined with respect to the time of sample data in which anomaly is detected or the current time, or may be a predetermined absolute time (for example, 0:00 to 24:00) including the time of sample data in which anomaly is detected. The graph production parameter information corresponds to information indicating extraction of measured data of Variable A in the range of time t1 to t2 and production of a histogram of each class having a fixed width.

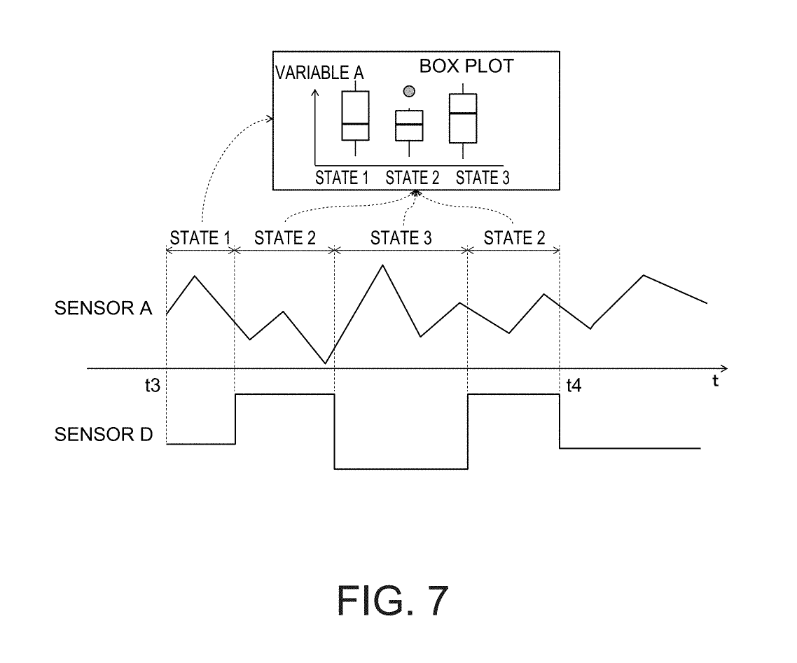

FIG. 7 illustrates an exemplary box plot. Variable A is same as that in FIGS. 4 to 6. Variable D represents a value of Sensor D. Variable D has three states of State 1, State 2, and State 3, and thus Sensor D has three values. This box plot created indicates distribution of the value of Variable A for State 1, State 2, and State 3 of Variable Din the range of time t3 to t4. In FIG. 7, a circle is a symbol indicating an outlier. The graph production parameter information corresponds to information indicating extraction of measured data in the range of time t3 to t4 and production of a box plot indicating distribution of the value of Variable A for each state of Variable D.

The graph display changer 150 creates a graph based on a graph production instruction (graph display change instruction) from the maintenance person, and replaces a graph displayed on the diagnosis evaluation screen (FIG. 3) with the graph instructed by the maintenance person. The maintenance person performs an operation to instruct graph production through the input device 800 by referring to the diagnosis evaluation screen. Specifically, the maintenance person performs the graph production instruction by determining the graph production parameter information and specifying the determined parameter information. When two or more graphs are displayed on the screen, a graph to be replaced may be specified. The content of the specified parameter information includes, for example, at least one of selection, change, addition, and deletion of a graph type, selection, change, addition, and deletion of a variable used for graph display, and specification and change of a condition on data extraction from measured data. In addition, a display scale, a display range, and the like of a graph may be specified as the parameter information. The graph display changer 150 creates a graph based on the parameter information specified by the maintenance person and displays the created graph on the diagnosis evaluation screen. The graph production instruction from the maintenance person may be performed at a plurality of times. In this case, the graph display changer 150 creates a graph and displays the graph on the diagnosis evaluation screen at each reception of the graph production instruction.

When the displayed graph is useful for determining the validity of a diagnosis result (including a case in which the diagnosis result by the diagnoser 120 is determined to be correct, and a case in which the diagnosis result is determined not to be correct and corrected by the maintenance person), the maintenance person presses the graph confirmation button 909 to register parameter information and the like of the graph to the display history database 230. The pressing of the graph confirmation button 909 indicates a graph registration instruction. Alternatively, when a first graph created by the graph creator is useful for determining the validity of a diagnosis result and thus no graph production instruction is performed, too, the maintenance person may press the graph confirmation button 909 to register parameter information and the like of the graph to the display history database 230. When two or more graphs are displayed, any graph to be registered may be displayed selectable so that parameter information and the like of only a selected graph are registered.

A graph useful for determining the validity of a diagnosis result desirably allows visual determination of whether anomaly detection is correctly performed or whether factor classification is correctly performed. In a case of a trend graph or a scatter diagram, the visual determination depends on whether determination of whether sample data as a diagnosis target is an outlier is possible based on a calculated distance of the graph from a graph or a point of other sample data. The distance may be an existing distance scale such as Manhattan distance, Euclidean distance, or DTW. The graph desirably allows clear identification that sample data as a diagnosis target belongs to an outlier, which is achieved by, for example, a bold line in a trend graph illustrated on the upper-left side in FIG. 8, a hatched circle in a scatter diagram illustrated on the upper-right side in FIG. 8, gray-colored data in a histogram illustrated on the lower-left side in FIG. 8, and gray-colored data in a box plot illustrated on the lower-right side in FIG. 8.

The display history database 230 stores parameter information and the like of a graph selected by pressing of the graph confirmation button 909 by the maintenance person.

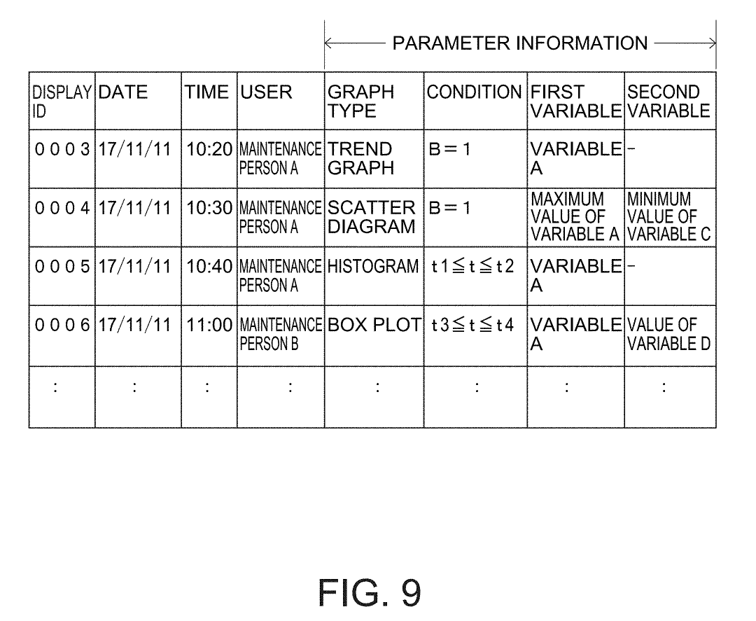

FIG. 9 illustrates an exemplary display history database. A plurality of entries each including a display ID, a date, a time, a user, and parameter information (graph type, condition, first variable, and second variable) are registered to the database. In this example, the entry of display ID 0003 corresponds to the trend graph illustrated in FIG. 4, the entry of display ID 0004 corresponds to the scatter diagram illustrated in FIG. 5, the entry of display ID 0005 corresponds to the histogram illustrated in FIG. 7, and the entry of display ID 0006 corresponds to the box plot illustrated in FIG. 9. The display ID is the ID of an entry. The date and time are a date and a time when an entry including the parameter information is registered to the database. The user is a maintenance person who registered an entry. The parameter information includes a graph type, a condition, and graph variables (the first and second variables). The condition is a condition (data extraction condition) on extraction of data used for graph production from measured data. For example, “B=1” indicates use of data of other variable (in this example, data of Variable A) for which the value of Variable B (Sensor B) is one. The graph type, the data extraction condition, and the graph variables are included in the parameter information in this example, but at least one thereof may be included. For example, when only the data extraction condition is specified, the graph type and the variables may be those determined in advance.

When the diagnostic device 100 diagnoses a plurality of systems or when an applied diagnosis model is switched between operation modes, classification items may be provided for the target systems or the operation modes, and a display history may be separately stored for each diagnosis target or each operation mode. This allows optimization of graph display for each diagnosis target or each operation mode.

The diagnosis result register 160 provides a function of correcting a diagnosis result output from the diagnoser 120. The diagnosis result includes whether anomaly is detected and a factor classification result. The maintenance person checks the diagnosis evaluation screen displayed on the screen display device 900 and determines whether to correct one or both of the anomaly detection and the factor classification result. When the correction is to be performed, the maintenance person presses the diagnosis correction button 906 through the input device 800 to perform a correction operation. A corrected content is reflected on the diagnosis evaluation screen. After the correction or when no correction is needed, the maintenance person presses the diagnosis approval button 907 through the input device 800 to perform an operation to approve the diagnosis result. Upon the approval operation, the diagnosis result register 160 registers the diagnosis result (whether anomaly is detected and the factor classification result) approved by the maintenance person to the diagnosis history database 240. The following describes an exemplary specific case of the diagnosis result correction.

For example, when the diagnoser 120 determines that anomaly is detected but the maintenance person determines that the determination is false based on the content of a graph, the maintenance person performs a correction operation to determine that no anomaly is detected (in other words, a diagnosis target system is normal). In this case, no anomaly factor classification is needed, and a classification result by using a factor classification model, which is displayed on the diagnosis evaluation screen, may be deleted.

When the diagnoser 120 determines that no anomaly is detected (in other words, a diagnosis target system is normal) but the maintenance person determines that the determination is false based on the content of a displayed graph, the maintenance person performs a correction operation to determine that anomaly is detected. When an anomaly factor can be determined based on the content of the graph, the maintenance person inputs the anomaly factor. When no anomaly factor can be determined, the maintenance person may input information indicating that an anomaly factor is unknown.

When the diagnoser 120 determines that no anomaly is detected and the maintenance person determines that the determination is correct based on the content of a graph but a factor classification result is wrong, the maintenance person performs an operation to correct an anomaly factor. The operation to correct an anomaly factor may be performed by selecting an anomaly factor determined to be correct by the maintenance person from among a plurality of candidates, or by directly inputting a value indicating an anomaly factor.

When the diagnoser 120 determines that no anomaly is detected and the maintenance person determines that the determination is correct based on the content of a graph, an approval operation may be performed without a correction operation. When the diagnoser 120 determines that anomaly is detected and the maintenance person determines that the determination is correct based on the content of a graph and an anomaly factor is correct, an approval operation may be performed without a correction operation.

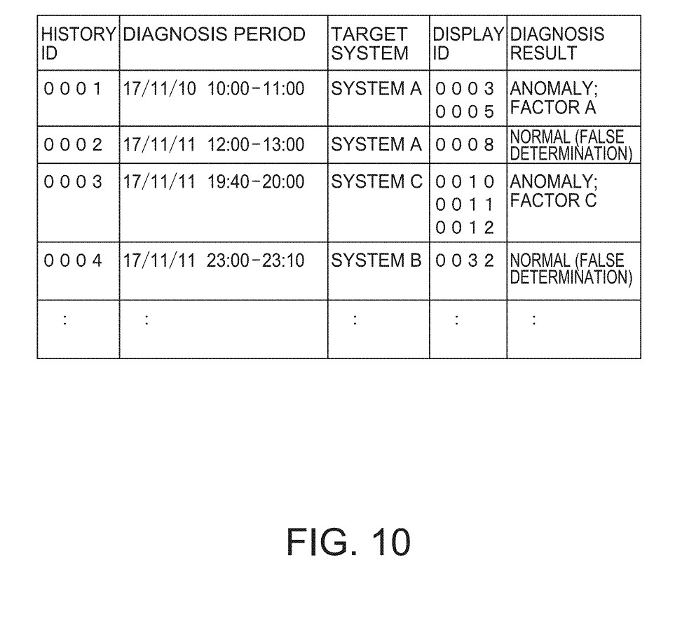

FIG. 10 illustrates an example of the diagnosis history database 240. A plurality of entries each including a history ID, a diagnosis period, a target system, a display ID, and a diagnosis result are registered to the database. The history ID is an ID for identifying an entry.

The diagnosis period is a period in which diagnosis is performed. Anomaly diagnosis is performed once or a plurality of times in the diagnosis period. Once anomaly is detected in a plurality of times of anomaly diagnosis, it is notified on a diagnosis result screen that the anomaly is detected. When anomaly diagnosis is performed a plurality of times in the diagnosis period, the diagnosis result screen may be displayed at end of the diagnosis period.

The target system is a system as a diagnosis target.

The display ID is used by the maintenance person to determine the validity of the diagnosis result, and indicates the display ID (refer to FIG. 9) of an approved graph. Specifically, the display ID is the display ID of a graph selected by pressing of the graph confirmation button 909 on the diagnosis result screen. For example, the entry of history ID 0001 indicates that graphs of display IDs 0003 and 0005 are determined to be useful for determining the validity of a result of diagnosis by the diagnoser 120 and approved by the maintenance person.

The diagnosis result indicates whether anomaly is detected and an anomaly factor when anomaly is detected. When the maintenance person has performed correction, information on the correction is noted. For example, the entry of history ID 0002 has a diagnosis result of “normal (false determination)” because the diagnoser 120 detects anomaly but the maintenance person determines that the anomaly does not exist. A similar note is performed when an anomaly factor is corrected.

The graph creator 140 creates a graph for a result of diagnosis by the diagnoser 120 based on the display history database 230 and the diagnosis history database 240. In this manner, a graph useful when referred to by the maintenance person to evaluate the result of diagnosis by the diagnoser 120 is calculated. For example, anomaly is detected for diagnosis target system A and an anomaly factor is determined to be factor A. This case matches with the entry of history ID 0001 in the diagnosis history database 240 illustrated in FIG. 10. This entry has display IDs 0003 and 0005, which correspond to display IDs 0003 and 0005 of the display history database 230 in FIG. 9. This indicates that, in a past identical diagnosis result, a trend graph of the value of Variable A when Variable B has a value B=1 and a histogram of the value of Variable A between time t1 to t2 were useful for diagnosis by the maintenance person. This leads to expectation that graphs effective for evaluation of a result of diagnosis by the diagnoser 120 can be presented to the maintenance person by producing and displaying a trend graph and a histogram with a condition same as that in the past. The following describes the graph creator 140 in detail.

The graph creator 140 receives, from the diagnoser 120, information on whether anomaly is detected and information on an anomaly factor when anomaly is detected. The graph creator 140 refers to the diagnosis history database 240 based on these pieces of information. It is determined whether the diagnosis history database 240 stores an entry recording a past diagnosis result of an identical anomaly factor for a diagnosis target system same as that for this time. When such an entry is recorded, the display ID of the entry is specified, and parameter information corresponding to the display ID is specified from the display history database 230. The graph creator 140 creates a graph based on the specified parameter information. For example, the graph creator 140 extracts data from measured data in accordance with a data extraction condition included in the parameter information, acquires, from the extracted data, one or a plurality of variables indicated by the parameter information, and creates a graph of a type indicated by the parameter information by using the acquired variables.

When the diagnosis history database 240 stores a plurality of entries each recording an anomaly diagnosis result of an identical factor, a plurality of graphs corresponding to all display IDs included in the entries maybe generated and displayed on the screen display device 900. In this case, a graph, the display ID of which appears a larger number of times may be displayed preferentially (for example, sequentially from the top of the screen). Alternatively, a graph, the display ID of which appears a larger number of times, the number of times being equal to or smaller than an upper limit value, may be preferentially selected and displayed.

When no entry recording an anomaly diagnosis result of an identical factor is registered to the diagnosis history database 240, the graph creator 140 creates a graph by using the display history database 230 only. The following describes processing of producing a graph by using the display history database 230 only.

The graph creator 140 creates a graph by using information on entries included in the display history database 230. An entry for the same maintenance person may be used to create a graph for this time. When the display history database 230 includes the item of diagnosis target system, an entry for the same diagnosis target system may be used to create a graph for this time. Statistics information calculated from entries in the display history database 230 may be used to create a graph. The statistics information may be the number of entries tallied for each graph type. The number of entries may be calculated for each user, or a total number of entries may be calculated for all users. When the display history database 230 includes the item of diagnosis target system, the statistics information may be calculated for each diagnosis target system.

As a specific example, a graph for this time may be created based on parameter information same as that of a graph approved by the same maintenance person of the current diagnosis at diagnosis a predetermined number of times before (for example, the previous diagnosis). This is because a graph once subjected to evaluation by the maintenance person is estimated to be less deviated from preference of the maintenance person. When the display history database 230 includes the item of diagnosis target system, parameter information same as that of a graph approved by the same maintenance person at diagnosis a predetermined number of times before (for example, the previous diagnosis) may be used for a diagnosis target system same as that for this time.

A graph for this time may be created with parameter information same as that of a graph, the display ID of which appears the largest number of times, by using an entry for a maintenance person same as that for this time. When the display history database 230 includes the item of diagnosis target system, a graph may be created with parameter information same as that of a graph, the display ID of which appears the largest number of times, by using an entry of a diagnosis target system same as that for this time and a maintenance person same as that for this time. Alternatively, a graph may be created with parameter information same as that of a graph, the display ID of which appears the largest number of times in total, by using an entry of a diagnosis target system same as that for this time irrespective of the maintenance person. The number of times that a display ID appears may be tallied in a period of a fixed time range. For example, the tally may be performed up to a fixed time before the current time or a diagnosis time for this time.

When the maintenance person has performed a display change operation on a graph of a certain diagnosis target system in identical or similar tendency, a graph provided with the same change in advance may be displayed the next time for this diagnosis target system. For example, when the number of pieces of sample data increases proportionally with time, and thus the display range of a graph needs to be continuously increased, a load on the maintenance person can be reduced by performing the above-described processing. The following describes specific examples of processing using the graph display change tendency.

The first example is a method of displaying, when the number of times that an identical change operation or an identical change operation pattern is performed in a past history over a fixed period exceeds a threshold, a graph changed through an identical operation or an identical operation pattern at the next graph generation.

The second example is a method of classifying change operations into classes in advance, checking a frequency at which operations belonging to each class are performed, and producing, when the number of times that operations belonging to a class are performed exceeds a threshold, a graph provided with all operations belonging to the class at the next graph generation. In this method, the tendency of a change operation performed by the maintenance person can be roughly reflected on the graph, which can lead to reduction of a load on the maintenance person when changing graph display.

As described above, the method of graph production by the graph creator 140 includes a method using both of the diagnosis history database 240 and the display history database 230, and a method using only the display history database 230. The methods each provide the maintenance person with a graph effective for evaluation of a result of diagnosis by the diagnoser 120, and support reduction of a time taken for evaluating the diagnosis result.

The above-described graph production utilizing display change in identical or similar tendency may be combined with graph production using both of the diagnosis history database 240 and the display history database 230. For example, a graph on which tendency is reflected may be created when the graph production is performed by using parameter information of a graph used when an anomaly diagnosis result of an identical factor is obtained.

The alarm 170 notifies information in accordance with a diagnosis result to a terminal 171 used by the maintenance person. This notification may be performed through transmission by electronic mail, display of a pop-up message on an operation screen of the terminal 171, or notification in predetermined instrument management protocol, or may be performed by any other means. Upon reception of the notification, the maintenance person can know that the diagnosis result as an evaluation target is obtained. A condition and a frequency with which the alarm 170 performs the notification to the terminal 171 are not particularly limited. For example, the notification may be performed only when an anomaly detection result is obtained. Alternatively, at each acquisition of a diagnosis result indicating the anomalous or normal state, information on the acquisition may be notified to the terminal 171. In a case of sample data with a long time interval, the notification may be performed to the maintenance person at each diagnosis. In a case of sample data with a short time interval, the notification may be performed when the number of diagnosed sample data exceeds a threshold. Elapse of a certain time since the previous notification may be added as another condition.

The following describes the diagnosis model generator 110. The anomaly detection model generator 110a of the diagnosis model generator 110 generates an anomaly detection model, and the factor classification model generator 110b of the diagnosis model generator 110 generates a factor classification model. The generation of these models is performed by using measured data in the measurement database 210 as learning data.

The diagnosis model generator 110 creates an anomaly detection model and a factor classification model when the diagnostic device 100 starts or when a new system or device is added as a diagnosis target. In addition, a model specialized for a case in which the existing system is placed under a particular condition may be generated. The particular condition means an installation environment, an operation mode, a load situation, and the like of a system or device. To generate a model specialized for a case in which the existing system is placed under a particular condition, only measured data when the existing system is placed under the particular condition may be extracted from among measured data acquired from the existing system and stored in the measurement database 210, and may be used as learning data

When learning data used to generate an anomaly detection model does not include or hardly includes anomalous data and thus a large number of pieces of sample data are assumed to be normal data, unsupervised learning may be performed. The unsupervised learning is performed to generate a model indicating the normal state of a diagnosis target system, and anomaly detection is performed by using the model.

It is supposed that sample data acquired from a system of social infrastructure such as power generation station, plant, or railway mostly belongs to normal data and includes almost no anomalous data. Thus, measured data is used intact as learning data to generate a model representing the normal state of a diagnosis target system by unsupervised learning, and the model is used as an anomaly detection model. In this case, anomaly detection can be performed based on the distance of newly obtained sample data from the anomaly detection model. The unsupervised learning model may be achieved by the one-class support vector machines (SVM), the k-nearest neighbor algorithm, and the local outlier factor (LOF).

When only normal-anomalous properties of part of sample data are identified, semi-supervised learning can be performed. Accordingly, a semi-supervised anomaly detection model can be generated.

For example, when several tens of thousands of pieces of sample data acquired from a system having a low anomaly occurrence rate are used for supervised learning, labeling needs to be performed on all pieces of sample data.

The labeling provides each piece of sample data with an identifier indicating a property, and the identifier is a label indicating a normal or anomalous state in a case of an anomaly detection model. In a case of a factor classification model to be described later, the identifier is a label identifying a factor. The labeling of each sample data by the skilled maintenance person is difficult because of actual workload or the like in some cases. Semi-supervised learning enables generation of an anomaly detection model when part of sample data is provided with a label indicating the normal or anomalous state.

When all pieces of sample data used as learning data can be each provided with a label indicating the normal or anomalous state, a model may be generated by supervised learning.

In the embodiment of the present invention, the labeling is not only performed at a timing when a diagnosis target system is newly added or when the diagnostic device 100 is initially set. The labeling of measured data also includes addition of a diagnosis result to the diagnosis result register 160 while the diagnostic device 100 is operational.

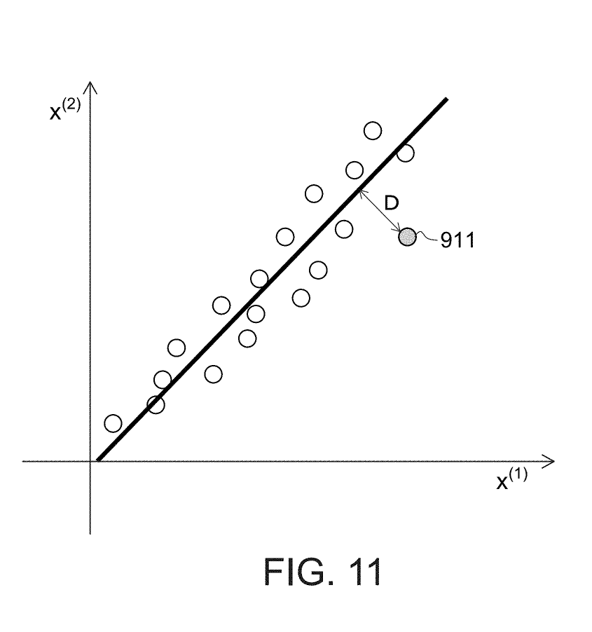

Examples of the anomaly detection model generated by the anomaly detection model generator 110a include a regression model of linear regression or the like. FIG. 11 exemplarily illustrates a linear regression model. The horizontal axis x⁽¹⁾ and the vertical axis x⁽²⁾ represent explanatory variables. In the embodiment of the present invention, an explanatory variable may be, for example, a measured value of a sensor or a value calculated from measured values of a plurality of sensors. This regression model is generated from measured data in the normal state, and the distance D between sample data 911 and a regression line is defined to be an anomaly degree. It can be estimated that anomaly occurs to the diagnosis target system when the anomaly degree exceeds a threshold.

An anomaly detection model may be generated by a clustering method. Clustering is an exemplary unsupervised classification. The clustering method may be a general-purpose method such as hierarchical clustering or k-means clustering. Examples of the method include a method of determining sample data to be anomalous when the sample data belongs to no cluster, a method of determining sample data to be anomalous when the sample data belongs to a cluster far away from a center cluster, and a method of determining sample data to be anomalous when the sample data belongs to a cluster in which the number of samples is smallest or not larger than a predetermined value.

Alternatively, an anomaly detection model can be generated by using neural network or the k-nearest neighbor algorithm. When it can be assumed that normal data is positioned near the center of normal distribution, anomaly detection may be performed by a statistical method. The above-described methods are exemplary, and a method and a model used for anomaly detection are not particularly limited.

The factor classification model generator 110b generates a factor classification model for estimating an anomaly factor. The specification of an anomaly factor allows the maintenance person or the like to take a measure appropriate for the anomaly factor. The factor classification model may be generated by various methods belonging to unsupervised learning, semi-supervised learning, and supervised learning, but the following describes an example using the random forest and the k-nearest neighbor algorithm.

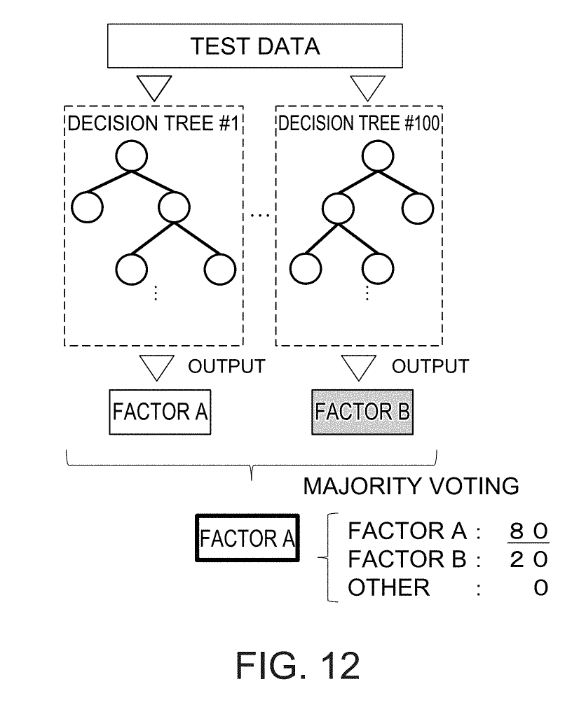

FIG. 12 illustrates exemplary classification by using the random forest. In the random forest, first, processing of extracting “n” samples from one data set of “n” samples in a duplicate manner is repeated “B” times to create “B” new sample sets. The number “B” of sample sets is determined with taken into account the number of samples and property of original learning data, and is usually several hundreds to several thousands. This process is called bootstrap. Hereinafter, a new sample set is referred to as a bootstrap sample. In the present embodiment, a sample corresponds to sample data. It is assumed that each piece of sample data is anomalous data and an anomaly factor thereof is known.

Subsequently, a decision tree is generated as a classifier by using each bootstrap sample as learning data. Accordingly, “B” decision trees are generated. The generation is performed by randomly selecting “m” explanatory variables from among explanatory variables in the learning data. When there are “a” explanatory variables, “m”=[sqrt]“a” explanatory variables are typically selected from among the “a” explanatory variables. This selection can achieve lower correlation between the decision trees, and an increased classification accuracy. When the number of explanatory variables is small and less than 10, all or most of the explanatory variables may be selected and used.

Determination of a node splitting method (method of generating a child node from a node) can be performed by searching a method that minimizes, for example, the Gini coefficient of 1−Σpi² or the entropy of −Σᵢ log pᵢ. In the expressions, pᵢ represents a probability that event i occurs. A weighted combination of the Gini coefficient and the entropy may be used as an index. The splitting method may be determined by any other method that obtains decision trees appropriate for prediction.

The node splitting ends when a predetermined condition is satisfied. The end condition of the node splitting is typically the number of samples belonging to each node. For example, the end condition is satisfied when the number of samples of the node reaches at one. Any other condition may be used. For example, the end condition may be satisfied when the depth of the node is equal to or larger than a threshold or when the node includes only samples belonging to an identical property. Nodes of each decision tree other than terminal nodes thereof are explanatory variables, and the terminal nodes are each assigned a label indicating a factor.

“B” decision trees are obtained by executing the above-described processing on each of the “B” bootstrap samples. In factor estimation, sample data as a diagnosis target is provided to each of the root nodes of the “B” decision trees, and majority voting is performed with outputs from the “B” decision trees. A factor having the largest number of outputs is adopted as a factor estimation result. Alternatively, the fraction (probability) of each factor may be adopted as an estimation result.

Influence of any noise in original data can be reduced by performing the bootstrap and classification by using a plurality of decision trees in this manner. The decision trees perform classification independently from each other, and thus calculation can be executed in parallel to achieve a reduced processing time.

In the example illustrated in FIG. 12, 80 decision trees estimate factor A, and 20 decision trees estimate factor B. In this case, factor A is presumed to be the most potential factor by majority voting. The certainty of the presumption can be indicated by understanding that factor A is correct with a probability of 80% and factor B is correct with a probability of 20%.

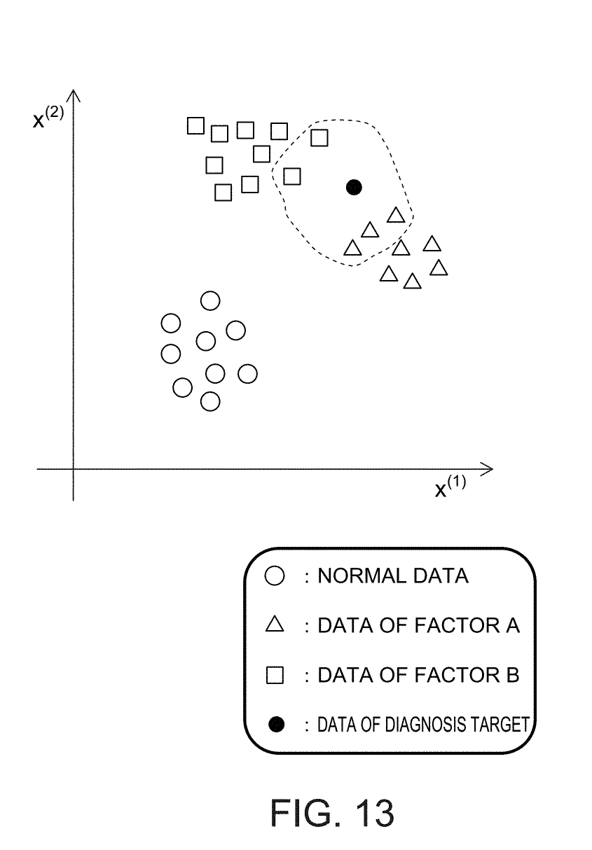

FIG. 13 illustrates an example in which factor classification is performed by using the k-nearest neighbor algorithm. In FIG. 13, the horizontal axis x⁽¹⁾ and the vertical axis x⁽²⁾ represent explanatory variables. Each piece of sample data is provided with a label indicating the normal or anomalous state, and sample data as anomalous data is provided with a label indicating a factor.

“k” (for example, five) pieces of sample data nearest to sample data as a diagnosis target are specified. As indicated by a dashed line, three pieces of sample data of factor A and two pieces of sample data of factor B are specified. In this case, anomaly is attributable to factor A with a probability of 60% or to factor B with a probability of 40%.

The above description is made on the case in which mutually different models are prepared as an anomaly detection model and a factor classification model. However, when possible, anomaly detection and factor classification can be both performed by using one model, by using only the one model. In such a case, one model serves as an anomaly detection model and a factor classification model.

In the above description, diagnosis is performed by using one diagnosis model (anomaly detection model or factor classification model) and result display (refer to FIG. 3) is performed, but diagnosis may be performed by using two diagnosis models to display two diagnosis results. It is expected that the maintenance person performs more accurate determination by using the two diagnosis results.

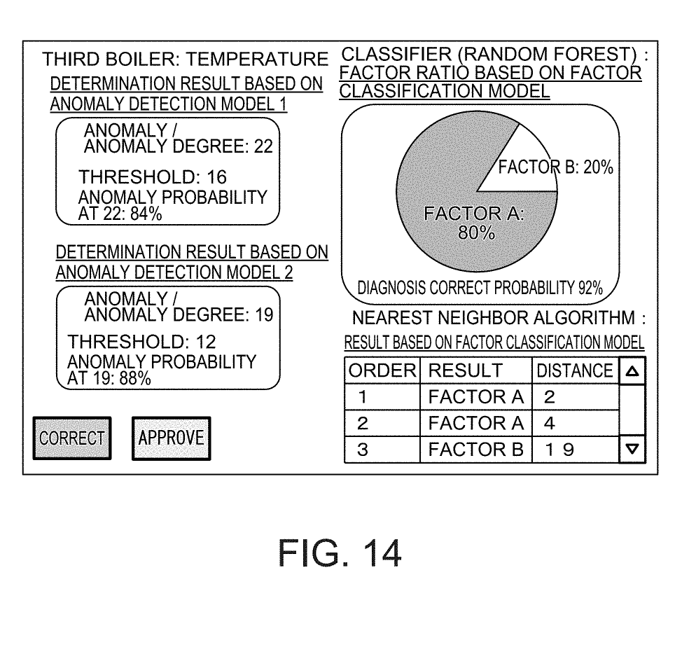

FIG. 14 illustrates another exemplary display of diagnosis result information. In the example illustrated in FIG. 14, results of determination by using two anomaly detection models, and classification results by using two factor classification models are displayed.

The results of determination by using two anomaly detection models are displayed on the left side in FIG. 14. The classification results by using two factor classification models are displayed on the right side in FIG. 14.

As illustrated on the left side in FIG. 14, anomaly determination is made by using each of the two anomaly detection models. An anomaly degree, a threshold, and an anomaly probability are displayed in addition to the anomaly determination result. The anomaly degree is an index indicating the degree of deviation of sample data determined to be anomalous from normal data. In the above-described exemplary linear regression model illustrated in FIG. 11, the distance from the straight line corresponds to the anomaly degree. The threshold is a value compared with the anomaly degree to perform anomaly determination. For example, it is determined that sample data is normal data (a diagnosis target is normal) when the anomaly degree of the sample data is equal to or lower than the threshold, or it is determined that the sample data is anomalous data (the diagnosis target is anomalous) when the anomaly degree is higher than the threshold.

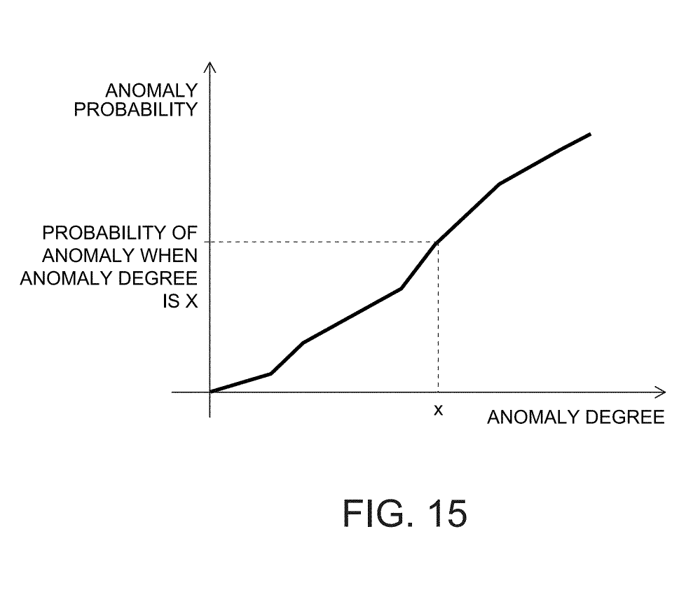

The anomaly degree represents the probability that the diagnosis target is anomalous. The anomaly degree is higher as the anomaly degree is further higher than the threshold. FIG. 15 illustrates an exemplary graph indicating a relation between the anomaly degree and the anomaly probability. Such a graph can be calculated by using learning data used for model learning after production of an anomaly detection model. The result generator 130 may generate such a graph together with diagnosis result information and display the graph on the screen display device 900.

The maintenance person may set the threshold of the anomaly degree through the input device 800 by referring to the graph illustrated in FIG. 15. In this case, the set threshold is stored in association with the anomaly detection model.

Alternatively, a threshold that maximizes an index such as a precision, a recall, or an F value may be calculated by a calculator. When distribution of the anomaly degree is approximated with normal distribution having a center at the average value of the anomaly degree, the anomaly probability can be calculated in accordance with the distance between the center of the normal distribution and the value of the anomaly degree of sample data as a diagnosis target. When the distance from the center of the normal distribution is expressed in “n” times the standard deviation, the probability that the diagnosis target is anomalous is higher as the value of “n” is larger. The value of “n” may be displayed in place of the anomaly probability.

A classification result when a classifier (random forest) is used and a classification result when the k-nearest neighbor algorithm is used are displayed as the classification results by using factor classification models on the right side in FIG. 14.

A pie chart is used to indicate the ratio of each factor as the classification result by using the classifier.

As the classification result by using the k-nearest neighbor algorithm, a factor corresponding to near sample data and the distance from the near sample data are displayed in ascending order of the distance in a table format. Information on any other near sample data can be referred by scrolling the table. When factor classification is performed by the k-nearest neighbor algorithm, the ratio of each factor may be displayed similarly to the case with a classifier.

The diagnosis result information display screen illustrated in FIG. 14 is merely exemplary. For example, only a factor having the largest number of appearances may be displayed as an anomaly factor classification result by using the k-nearest neighbor algorithm. Alternatively, a rank may be applied to each of a plurality of factors in descending order of appearance, and the factors may be displayed in an order in accordance with the rank. Among a plurality of anomaly detection models, only a diagnosis result by using an anomaly detection model with which anomaly determination is made may be displayed. Alternatively, statistical processing may be performed on diagnosis results by using a plurality of anomaly detection models, thereby displaying one diagnosis result.

When a diagnosis target system is determined to be normal by using each of a plurality of anomaly detection models, the diagnosis evaluation screen display may be omitted or the diagnosis result information may be displayed in a simplified content.

Among the components of the diagnostic device 100, the diagnosis model generator 110, the anomaly detection model generator 110a, the factor classification model generator 110b, the diagnoser 120, the anomaly detector 120a, the factor analyzer 120b, result generator 130, graph display changer 140, the graph display changer 150, the diagnosis result register 160, and the alarm 170 are achieved by an information processing device such as a calculator that includes at least one central processing unit (CPU) and a storage device and on which an operating system (OS) and software operate. Alternatively, those components may be achieved by cooperation of a plurality of distributed information processing devices. The information processing system according to the present embodiment includes a single information processing device or a plurality of distributed information processing devices.

The information processing device may be achieved by a virtual machine (VM), a container, or combination thereof.

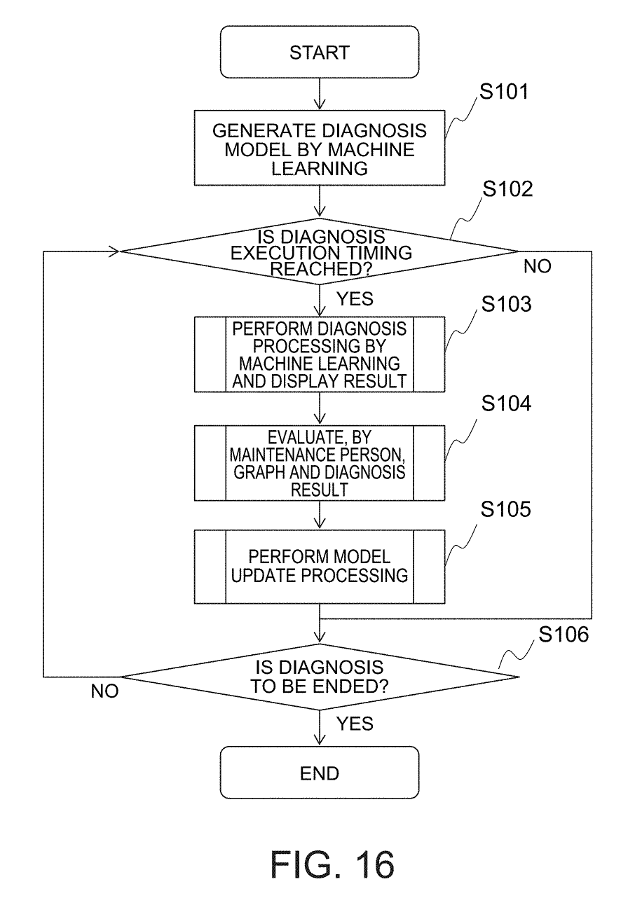

FIG. 16 is a flowchart illustrates the outline of the entire processing at the diagnostic device according to the first embodiment.

At step S101, the diagnosis model generator 110 generates a diagnosis model (anomaly detection model or factor classification model) by machine learning using the measurement database 210. The diagnosis model generator 110 stores the generated diagnosis model in the diagnosis model database 220. Labels such as a label indicating the normal or anomalous state and a label indicating an anomaly factor are applied to measured data in the measurement database 210 in advance in accordance with a learning method for an anomaly detection model or a factor classification model. This labelling may be performed, for example, through determination by the skilled maintenance person. Alternatively, when the normal or anomalous state and an anomaly factor are known in advance, the labelling may be performed based on the knowledge.

At step S102, it is determined whether a diagnosis execution timing is reached. For example, it is determined that the diagnosis execution timing is reached when sample data in an amount necessary for single diagnosis or sample data in an amount necessary for a plurality of times of diagnosis when diagnosis is performed a plurality of times in a diagnosis period is recorded in the measurement database 210. Alternatively, the maintenance person may input instruction information explicitly indicating diagnosis start, and the diagnosis execution timing may be set to be a timing when the instruction information is detected. The above-described timing is exemplary, and the diagnosis execution timing is not particularly limited.

The determination of the diagnosis execution timing is performed for each diagnosis target. For example, when diagnosis targets are system A and system B, the determination of the diagnosis execution timing is individually performed for system A and system B. When a diagnosis model is created for each state of a system, the determination of the diagnosis execution timing is performs for each state of a system. For example, when system C has state a and state β and a diagnosis model has been created for each state, whether the diagnosis execution timing is reached is determined for each state.

When it is determined that the diagnosis execution timing is reached, the process proceeds to the subsequent step S103. Otherwise, the process proceeds to step S106.

At step S103, diagnosis processing is performed based on the diagnosis model and a graph is created based on a result of the diagnosis processing, and then the result of the diagnosis processing and the graph are displayed on a screen. Process at step S103 will be described later in detail.

At step S104, the diagnosis result and the graph are evaluated by the maintenance person. As described above, the maintenance person may start the evaluation of the diagnosis result and the graph when notified by the alarm 170. Process at step S104 will be described later in detail.

At step S105, model update processing is executed on the diagnosis model based on the evaluation by the maintenance person at step S104. Process at step S105 will be described later in detail.

At step S106, whether to end the diagnosis is determined. When an end condition is satisfied, the diagnosis of a diagnosis target system ends. Exemplary end condition are reception of an end instruction from the maintenance person, and inputting of a command to power off the diagnostic device. Any end condition other than these conditions is applicable. When the diagnosis is continued, the process returns to step S102, whether the diagnosis execution timing is reached is determined.

The following describes steps S103, S104, and S105 in detail below.

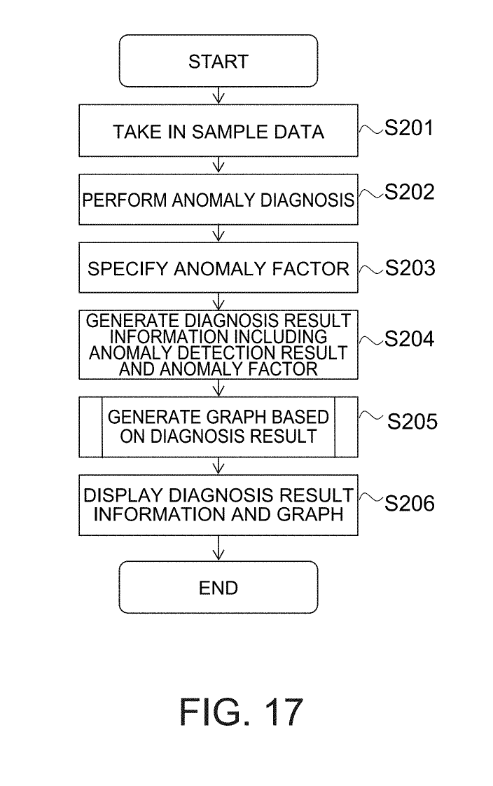

FIG. 17 illustrates a detailed flowchart of step S103 (diagnosis processing, graph production, and screen display of results thereof). The anomaly detector 120a of the diagnoser 120 acquires the sample data (S201), and performs anomaly diagnosis based on the anomaly detection model and the sample data (S202). When anomaly is detected, the factor analyzer 120b estimates an anomaly factor based on the factor classification model and the sample data (S203). When no anomaly is detected, no factor classification is performed. The diagnosis result generator 130 generates diagnosis result information based on the anomaly diagnosis result and outputs the information to the screen display device 900 (S204). The graph creator 140 creates a graph from the sample data and measured data based on the anomaly diagnosis result and the display history database 230 and the diagnosis history database 240 and outputs the created graph to the screen display device 900 (S205). The screen display device 900 displays the diagnosis result information and the graph on the diagnosis evaluation screen (S206). When no anomaly is detected at step S202, the following steps S203 to S206, S104, and S105 may be omitted. The diagnosis result information and the graph are displayed on the same screen, but may be displayed on separate screens.

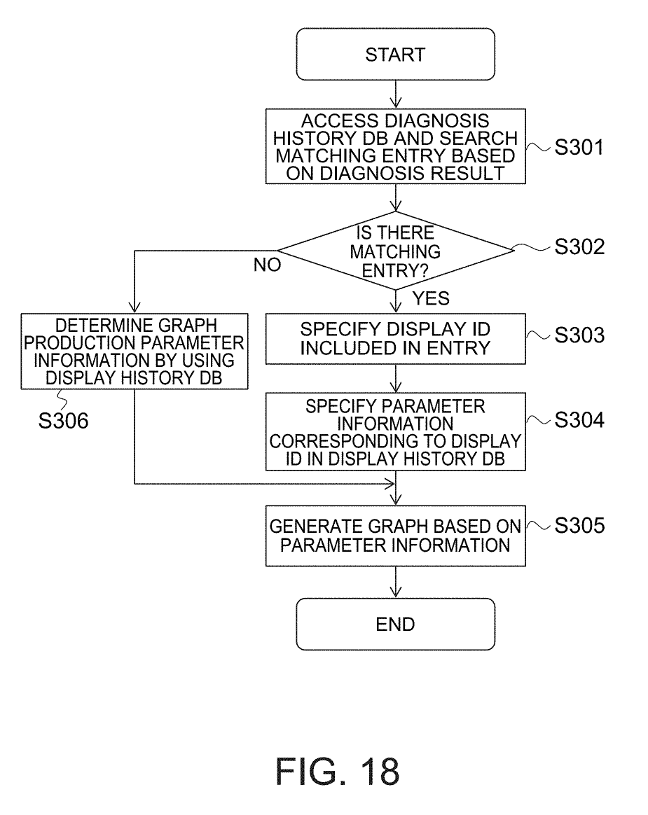

FIG. 18 illustrates a detailed flowchart of the graph production processing (S205) illustrated in FIG. 17. The diagnosis history database 240 is accessed based on the result of the anomaly detection by the anomaly detector 120a, the anomaly factor estimated by the factor analyzer 120b when anomaly is detected, and the identifier of the current diagnosis target system (S301). It is checked whether there is an entry with which matching is made for the identifier of the diagnosis target system, the anomaly detection result, and the anomaly factor (S302). When there is a matching entry, a display ID included in the entry is specified (S303). When there are a plurality of matching entries, one entry such as the latest entry may be selected, and a display ID included in the selected entry may be specified. Alternatively, a plurality or all of the entries may be selected, and all display IDs included in the selected entries may be specified. When a large number of display IDs are specified, predetermined number of display IDs that appear a larger number of times may be selected preferentially. The graph production parameter information corresponding to a specified display ID is specified in the display history database 230 (S304), a graph is created by using the specified parameter information and the measured data including the sample data (S305). When there is no matching entry at step S302, parameter information used to create a graph for this time is determined in the display history database 230 (S306). Then, a graph is created by using the specified parameter information and the measured data including the sample data (S305).

The following describes, in detail, step S104 illustrated in FIG. 16. At step S104, the diagnosis result and the graph are evaluated by the maintenance person.

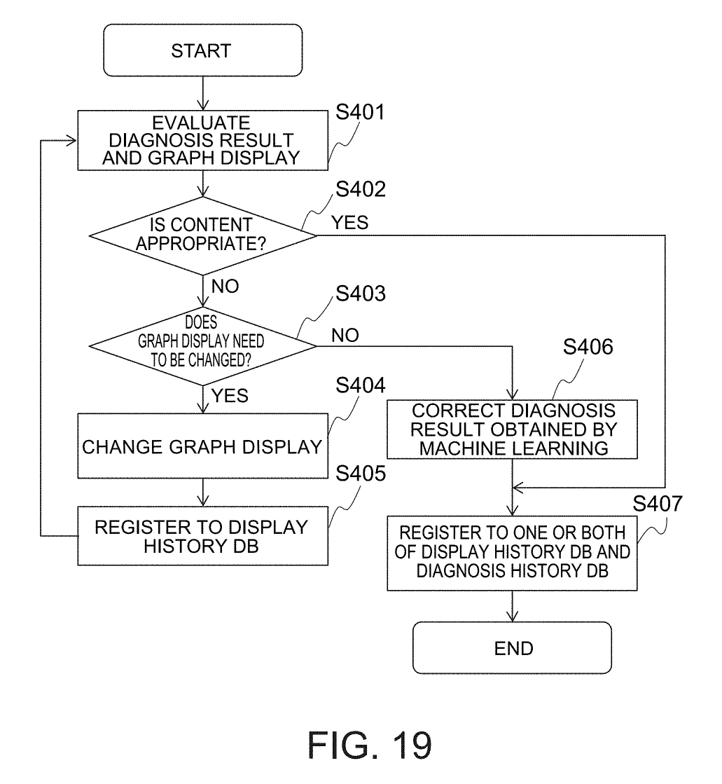

FIG. 19 is a flowchart illustrating the processing of the evaluation of the graph and the diagnosis result at step S104 in detail.

At step S401, the diagnosis result and the graph are evaluated by the maintenance person, and an operation instruction in accordance with the evaluation is received. Specifically, the maintenance person checks whether the result of the diagnosis based on the diagnosis model is correct by referring to the graph. When the diagnosis result is correct, the maintenance person performs an approval operation through the input device 800. When the diagnosis result is not correct, an operation to correct the diagnosis result is performed by receiving an operation for the correction. When the graph is not appropriate for evaluating the diagnosis result, the maintenance person performs an operation to change display of the graph. When the graph is appropriate, the maintenance person performs the approval operation. At least one of these operations is received.

At the next step S402, it is determined whether the diagnosis result and the graph are approved by the maintenance person. When the approval is obtained, the process proceeds to step S407. When the maintenance person cannot correct the diagnosis result nor determine the effectiveness of the graph, the process may proceed to step S407.

At step S407, when the diagnosis result and the graph are approved by the maintenance person, information related to the approved graph is registered to the display history database 230. In addition, information related to the approved diagnosis result is registered to the diagnosis history database 240 through the diagnosis result register 160.

When the diagnosis result correction operation or the graph display change operation is received from the maintenance person, the process proceeds to step S403.

At step S403, it is determined whether the graph display change operation is received from the maintenance person. When the change operation is received, the graph display changer 150 recreates a graph based on the parameter information instructed by the maintenance person and displays the graph on the screen display device 900 at step S404. The maintenance person determines whether to correct the diagnosis result based on the content of the new displayed graph by referring to the graph (S401). When it is determined that the new graph is useful for the determination of whether to correct the diagnosis result, a graph approval operation is received, and information related to the changed graph and registered to the display history database 230 (S405). When the maintenance person determines that graph display needs to be changed again, the graph change operation may be performed again to continue graph display change work without performing step S405 (NO at S402, S403, and S404).

After step S405, the process returns to step S401 where the maintenance person evaluates the diagnosis result and the graph again. When an operation to approve the diagnosis result and an operation to approve the graph are received, the process proceeds to step S408. When the graph approval operation is received but the diagnosis result correction operation is received, the process proceeds to step S406.

At step S406, the diagnosis result is corrected in accordance with the correction operation from the maintenance person. The diagnosis result correction includes at least one of correction of the anomaly detection result and correction of the anomaly factor.

At step S407, when the diagnosis result is corrected by the maintenance person at step S406, information related to the corrected diagnosis result is registered to the diagnosis history database 240.

The following describes, in detail, the model update processing at step S105 illustrated in FIG. 16. The model update processing is executed at each evaluation of a graph and a diagnosis result by the maintenance person in the process illustrated in FIG. 16, but does not necessarily need to be executed at each evaluation. The execution frequency of the model update processing can be determined with taken into account cost of a time, a calculation resource, and the like taken for the model update processing. The model update processing may be executed at a timing determined by a method different from that in the present process. For example, the model update processing may be performed in a period such as once per week. The model update processing may be executed each time when evaluation of a graph and a diagnosis result by the maintenance person is performed a certain number of times. The model update processing may be performed at a timing other than those described above.

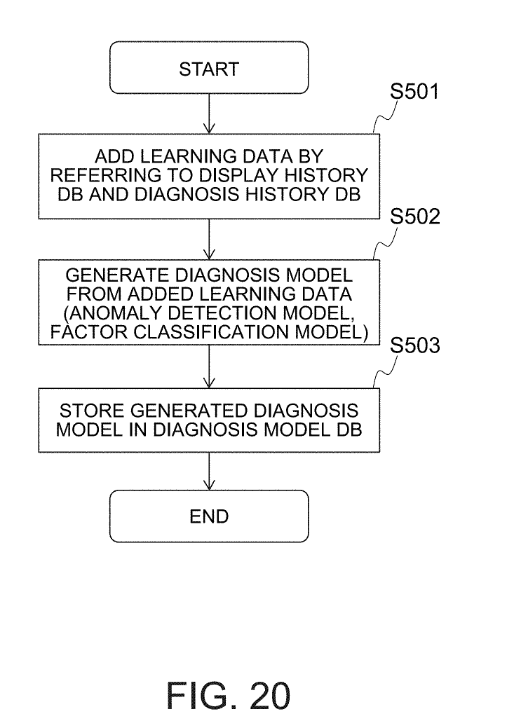

FIG. 20 is a flowchart illustrating the model update processing at step S105.

At step S501, additional learning data is prepared by referring to the display history database 230 and the diagnosis history database 240. Specifically, learning data is newly added by reflecting, on measured data, a diagnosis result recorded in the diagnosis history database 240.

The accuracy of a generated diagnosis model is expected to improve by increasing the number of samples of learning data in this manner. A model that allows more accurate prediction is more likely to be generated by using learning data on which a larger number of accurate determinations by the skilled maintenance person are reflected. More reliable learning can be performed by repeating the update of a diagnosis model and the addition of learning data.

At step S502, a diagnosis model is generated by using currently added learning data in addition to previously used learning data. Accordingly, a new diagnosis model that achieves an improved diagnosis accuracy as compared to the previous diagnosis model is generated. In the generation of a new model, change of a condition on model production such as addition and deletion of a variable or change of a splitting condition of child nodes in a case of the random forest may be performed. The variable and condition to be added may be a variable and a condition of parameter information newly registered to the display history database 230 and the diagnosis history database 240. The variable to be added may be extracted by a method such as multiple regression analysis. When the accuracy of a new model is compared with that of the previous model to find that the accuracy is improved, the existing model is replaced with the new model. The accuracy can be checked by a method such as cross validation. In the cross validation method, a model is generated by using part of learning data and verified by using the remaining learning data. Alternatively, the accuracy of an updated diagnosis model may be evaluated by using an estimated error and an anomaly detection rate to check whether the accuracy of the updated model is improved as compared to that of the original diagnosis model.

At step S502, a new diagnosis model may be additionally generated along with update of the existing diagnosis model.

At step S503, the diagnosis model generated at step S502 is stored in the diagnosis model database 220. A diagnosis model is generated for each diagnosis target system. Different diagnosis models may be generated for, for example, operation modes and environment conditions of the same diagnosis target system.

Learning data can be continuously added to repeat diagnosis model regeneration and verification by repeatedly executing the model update processing at steps S501 to S503 on a diagnosis model for an identical diagnosis target system. A more accurate diagnosis model on which diagnosis performed by the skilled maintenance person is reflected can be obtained with a larger number of the repetitions.

An improved learning data stored in the measurement database 210 and a diagnosis model stored in the diagnosis model database 220 can be transmitted from the diagnostic device 100 to another diagnostic device. This allows another diagnostic device to diagnose a power generation station, a plant, a vehicle, a device, and the like designed similarly to the diagnostic device 100 without newly performing preparation of learning data and generation of a diagnosis model. When a device or a system diagnosed by another diagnostic device has a slightly different configuration or is installed in a different environment, a high diagnosis accuracy is expected to be achieved by performing a small number of times of the model update processing.

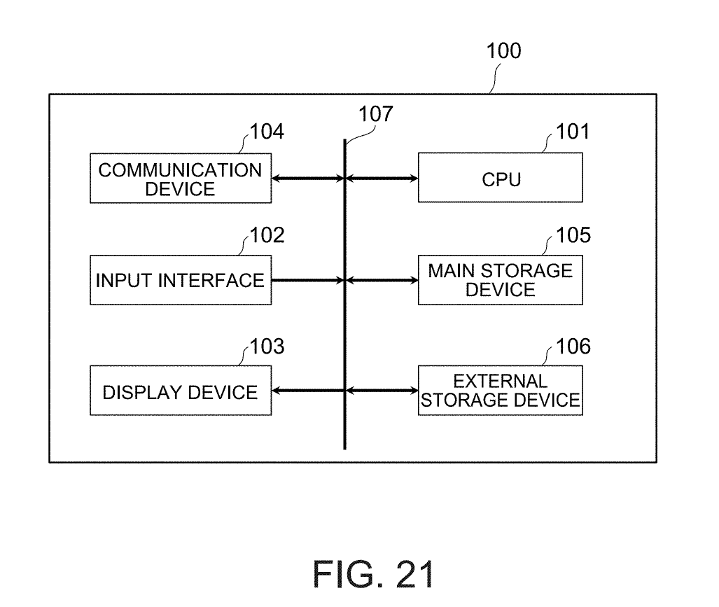

FIG. 21 illustrates a hardware configuration of the diagnostic device according to the present embodiment. The diagnostic device according to the present embodiment is achieved by a computer device 100. The computer device 100 includes a CPU 101, an input interface 102, a display device 103, a communication device 104, a main storage device 105, and an external storage device 106. These components are connected with each other through a bus 107.

The CPU (central processing unit) 101 executes a diagnosis program as a computer program on the main storage device 105. The diagnosis program achieves each above-described functional configuration of the diagnostic device. The functional configuration is achieved by the CPU 101 executing the diagnosis program.

The input interface 102 is a circuit for inputting an operation signal from an input device such as a keyboard, a mouse, or a touch panel to the diagnostic device.

The display device 103 displays data or information output from the diagnostic device. The display device 103 is, for example, a liquid crystal display (LCD), a cathode-ray tube (CRT), or a plasma display (PDP), but not limited thereto. Data or information output from the diagnosis result generator 130 or the graph creator 140 can be displayed on the display device 103.

The communication device 104 is a circuit configured to allow the diagnostic device to communicate with an external device in a wireless or wired manner. Measured data can be input from an external device through the communication device 104. The measured data input from the external device can be stored in the measurement database 210.

The main storage device 105 stores, for example, the diagnosis program, data necessary for executing the diagnosis program, and data generated through execution of the diagnosis program. The diagnosis program is loaded onto the main storage device 105 and executed. The main storage device 105 is, for example, a RAM, a DRAM, or an SRAM, but not limited thereto. The measurement database 210, the diagnosis model database 220, the display history database 230, and the diagnosis history database 240 may be established on the main storage device 105.

The external storage device 106 stores, for example, the diagnosis program, data necessary for executing the diagnosis program, and data generated through execution of the diagnosis program. The program and data are read by the main storage device 105 at execution of the diagnosis program. The external storage device 106 is, for example, a hard disk, an optical disk, a flash memory, or a magnetic tape, but not limited thereto. The measurement database 210, the diagnosis model database 220, the display history database 230, and the diagnosis history database 240 may be established on the external storage device 106.

The diagnosis program may be installed on the computer device 100 in advance or stored in a storage medium such as a CD-ROM. The diagnosis program may be uploaded on the Internet.

The diagnostic device may be achieved by the single computer device 100 or achieved as a system of a plurality of computer devices 100 connected with each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A diagnostic device comprising:
an anomaly diagnoser configured to perform anomaly diagnosis based on first measured data; and
a graph creator configured to determine parameter information for graph production in accordance with a result of the anomaly diagnosis and create a first graph from the first measured data based on the parameter information.

2. The diagnostic device according to claim 1, wherein
the parameter information includes data extraction condition, and
the graph creator extracts data from the first measured data based on the extraction condition and creates the first graph by using the extracted data.

3. The diagnostic device according to claim 1, wherein
the parameter information specifies a variable to be used, and
the graph creator generates the specified variable from the measured data and creates the first graph by using the generated variable.

4. The diagnostic device according to claim 1, wherein
the parameter information specifies a graphs type, and
the graph creator creates the first graph of the specified type.

5. The diagnostic device according to claim 1, wherein
when anomaly is detected by the anomaly diagnosis, the anomaly diagnoser estimates an anomaly factor based on the first measured data, and
a result of the anomaly diagnosis includes a result of the anomaly detection and anomaly factor in a case of the anomaly being detected.

6. The diagnostic device according to claim 1, wherein
the graph creator receives the parameter information and creates the first graph based on the received parameter information, and
adds the received parameter information to a history database,
the anomaly diagnoser performs anomaly diagnosis based on second measured data, and
the graph creator determines parameter information for graph production for the second measured data based on the history database and creates a second graph from the second measured data based on the determined parameter information.

7. The diagnostic device according to claim 6, wherein
the graph creator adds the received parameter information to the history database in association with a result of the anomaly diagnosis, and
the graph creator determines parameter information for graph production for the second measured data from the history data based on a result of anomaly diagnosis for the second measured data.

8. The diagnostic device according to claim 6, wherein the graph creator outputs the first graph and performs the addition of the received parameter information to the history database when having received a registration instruction for the output first graph.

9. The diagnostic device according to claim 8, wherein the graph creator outputs a plurality of the first graphs by receiving a plurality of times the parameter information for graph production and performing a plurality of times of production of the first graph, and adds, to the history database, only the first graph for which the registration instruction has been received among the first graphs.

10. The diagnostic device according to claim 6, further comprising a diagnosis model generator configured to generate a diagnosis model based on the history database, wherein the anomaly diagnoser performs anomaly diagnosis by using the diagnosis model.

11. A diagnostic method comprising:
performing anomaly diagnosis based on first measured data; and
determining parameter information for graph production in accordance with a result of the anomaly diagnosis and create a first graph from the first measured data based on the parameter information.

12. A non-transitory computer readable medium having a computer program stored therein which causes a computer to perform processes comprising:
performing anomaly diagnosis based on first measured data; and
determining parameter information for graph production in accordance with a result of the anomaly diagnosis and create a first graph from the first measured data based on the parameter information.
